(19) United States
(12) Patent Application Publication
(10) Pub. No.: US 2005/0235562 A1
(43) Pub. Date: Oct. 27, 2005

(54) Plastic ventilation window structure

(75) Inventor: Ben Hsu, Changhua Hsien (TW)

Correspondence Address: TROXELL LAW OFFICE PLLC;SUITE 1404, 5205 LEESBURG PIKE, FALLS CHURCH, VA, 22041, US

(73) Assignee: Ching Feng Blinds Ind. Co., Ltd.

(21) Appl. No.: 10/883,764

(22) Filed: Jul. 6, 2004

(30) Foreign Application Priority Data
Apr. 21, 2004 (TW) 093206154

(51) Int. Cl. E06B 7/08

(52) U.S. Cl. 49/74.1

(57) ABSTRACT

A plastic ventilation window structure includes a left/right side bracket, an upper/lower side bracket, support members, closure members, and a plurality of slats wherein the left and right side brackets have a recessed engagement groove indented at the corresponding inner side thereof respectively, and a pair of retaining ribs each having a slant tapered guide facet defining one end thereon properly protruding at the inner wall of the recessed engagement groove thereon. The closure member has a pair of arc and tapered guide ribs and stop ribs symmetrically extending at both lateral sides thereon to define a pair of retaining cavities there-between. In assembly, the retaining ribs of the recessed engagement grooves are precisely located at the retaining cavities of the closure members therein and closely limited in place at the guide ribs and stop ribs of the closure members there-between to locate the closure members stably at the left/right side brackets therein without detaching from the recessed engagement grooves thereof while the slats are pivotally rotated upwards or downwards by a linkage rod. In case of a smaller window frame, the closure members are reinforced in strength and securely held in place without the support members being applied thereto, economically saving the time and cost of processing to achieve the economical efficiency and boost the competitive power thereof.

### BACKGROUND OF THE INVENTION

The present invention is related to a plastic ventilation window structure, including a left/right side bracket, an upper/lower side bracket, support members, closure members, and a plurality of slats wherein the left and right side brackets have a recessed engagement groove indented at the corresponding inner side thereof respectively, and a pair of retaining ribs properly protruding at the inner wall of the recessed engagement groove therein to be registered with retaining cavities of the closure members thereof and limited by guide ribs and stop ribs defining both sides of the retaining cavities thereof; whereby, the closure members are securely located at the left/right side brackets therein without detaching from the recessed engagement grooves thereof while the slats are pivotally rotated upwards or downwards by a linkage rod. In case of a smaller window frame, the closure members of solid plastics are reinforced in strength and stably held in place without the support members being applied thereto, economically saving the time and cost of processing to achieve the economical efficiency and boost the competitive power thereof.

Please refer to FIGS. 1 to 2 inclusive. A conventional ventilation window 10 includes a left and right side brackets 11 having a recessed engagement groove 111 indented at the corresponding inner side therein respectively for a frame-shaped and metallic support member 12 and a closure member 13 with a pair of resilient hooks 131 to be engaged therewith. A pair of vertical shallow grooves 112 is symmetrically dented at the inner wall of the opening edge of the recessed engagement groove 111 thereof for arc positioning ribs 132 protruding at both outer lateral sides of the closure member 13 to be registered therewith. A proper space is preset at both upper and lower sections of the recessed engagement groove 111 thereof for an upper and lower side brackets 14 to be mounted thereto respectively to form a frame body. A number of engaging holes 133 are equidistantly disposed at the corresponding inner lateral side of the closure members 13 for pivoting posts 151 extending at both sides of a slat 15 to be registered therewith respectively. A linkage rod 16 is simultaneously attached to one side of each slat 15 so as to pivotally rotate the slats 15 upwards or downwards synchronically according to the movement of the linkage rod 16 in the opening/closing operation thereof to properly adjust the sheltering position of the ventilation window 10 thereof

There are some drawbacks to such conventional ventilation window. First, the closure members 13 are retained at the recessed engagement grooves 111 of the left/right side brackets 11 therein via the positioning ribs 132 simply abutted against the shallow grooves 112 without any other limitation effect for secure location thereby. When the pivoting posts 151 of the slats 15 are pivotally rotated at the engaging holes 133 therein, the closure members 13 are easily detached from the recessed engagement grooves 111 according to the movement of the slats 15 actuated by the linkage rod 16 in operation thereof. Thus, the closure members 13 must be pushed and relocated at the recessed engagement grooves 111 therein, which are rather poor in location effect. Second, the closure member 13 is formed of a hollow tube with a plurality of the engaging holes 133 disposed thereon for retaining the pivoting posts 151 of the slats 15, which easily reduce the strength of the closure member 13 thereof. In case of a smaller window frame, the support members 12 are still required to reinforce the stability of the left/right side brackets 13, uneconomically increasing the time and cost of processing and making the conventional ventilation window uncompetitive in the market. Third, the closure member 13, formed of a hollow tube with a plurality of the engaging holes 133 disposed thereon for retaining the pivoting posts 151 of the slats 15 thereby, is reduced in strength and tends to get deformed due to the gravity force and the frequent movement of the slats 15 in operation thereof

### SUMMARY OF THE PRESENT INVENTION

It is, therefore, the primary purpose of the present invention to provide a plastic ventilation window structure, including a left/right side bracket, an upper/lower side bracket, support members, closure members, and a plurality of slats wherein the left and right side brackets have a recessed engagement groove indented at the corresponding inner side thereof respectively, and a pair of retaining ribs properly protruding at the inner wall of the recessed engagement groove therein to be registered with retaining cavities of the closure members thereof and limited in place by guide ribs and stop ribs defining both sides of the retaining cavities thereof, whereby, the closure members are stably located at the left/right side brackets therein without detaching from the recessed engagement grooves thereof while the slats are pivotally rotated upwards or downwards by a linkage rod to achieve the best using condition thereof.

It is, therefore, the second purpose of the present invention to provide a plastic ventilation window structure wherein, in case of a smaller window frame, the closure members of solid plastics are reinforced in strength and securely held in place via the retaining cavities closely abutted against the retaining ribs of the recessed engagement grooves and the guide ribs and the stop ribs limiting at both sides of the retaining ribs thereof so that the support members are able to be omitted in assembly, economically saving the time and cost of processing to achieve the economical efficiency and boost the competitive power of the present invention thereof.

It is, therefore, the third purpose of the present invention to provide a plastic ventilation window structure wherein the closure members are made of solid plastics and reinforced in strength, efficiently avoiding the deformation due to the gravity force and the frequent movement of the slats in operation so as to improve the stability of the ventilation widow thereof.

### BRIEF DESCRIPTION OF THE DRAWINGS

FIG. 1 is a perspective and partially penetrating view of a conventional ventilation window in assembly.

FIG. 2 is a cross sectional view of the conventional ventilation window in assembly.

FIG. 3 is a perspective exploded view of the present invention.

FIG. 4 is a perspective and partially penetrating view of the present invention in assembly.

FIG. 5 is a cross sectional view of the present invention in assembly.

FIG. 6 is a perspective and partially penetrating view of another embodiment of the present invention in assembly.

FIG. 7 is a cross sectional view of another embodiment of the present invention in assembly.

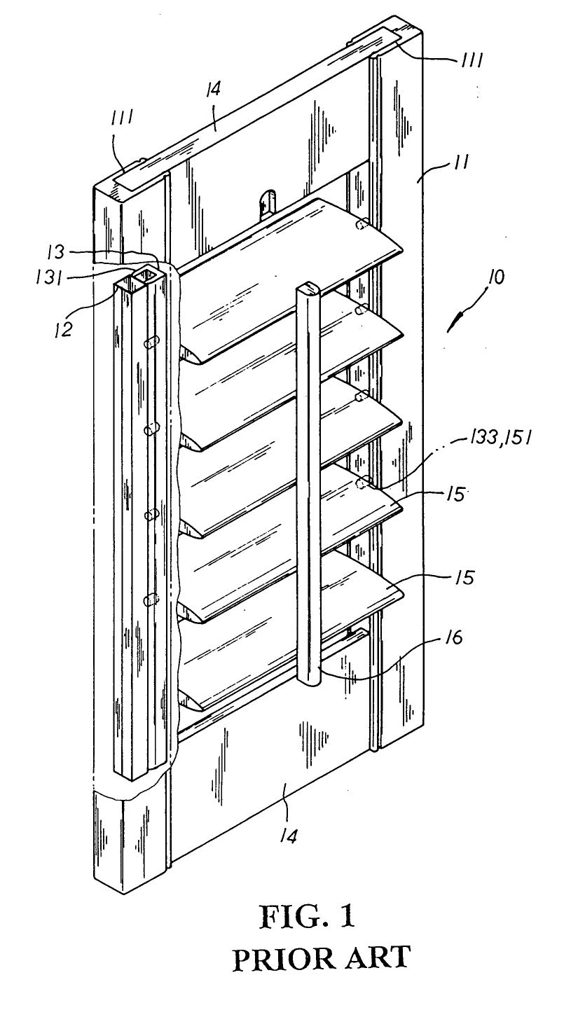

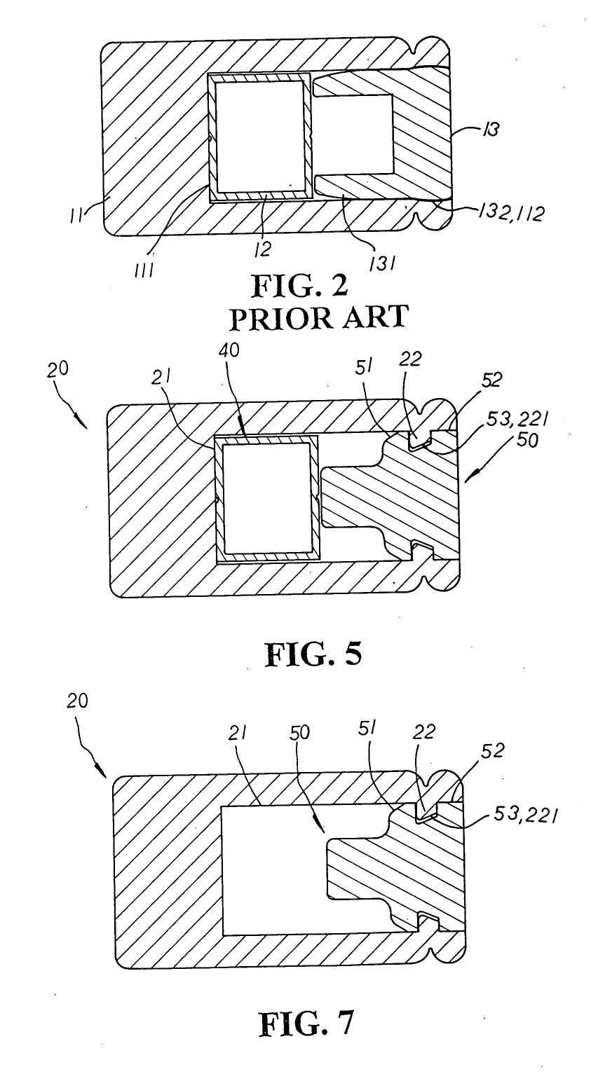

### DETAILED DESCRIPTION OF THE PREFERRED EMBODIMENTS

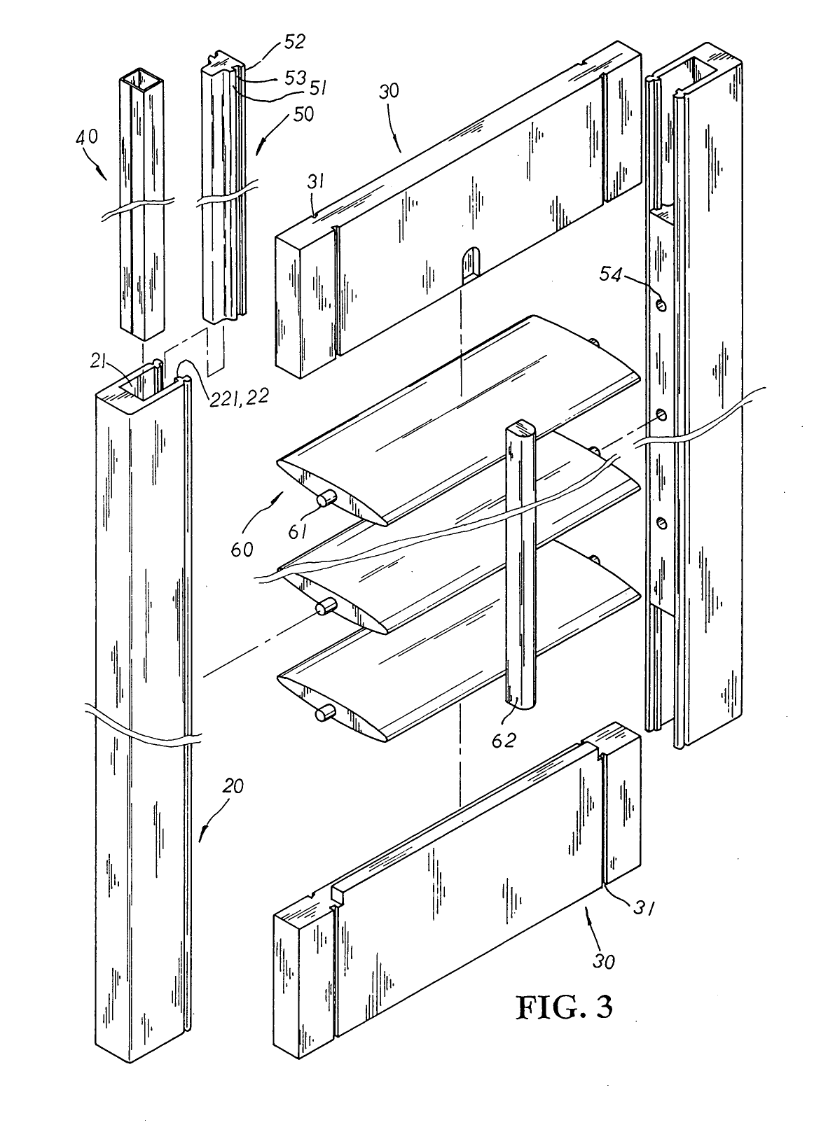

Please refer to FIG. 3. The present invention is related to a plastic ventilation window structure, including a left/right side bracket 20, an upper/lower side bracket 30, support members 40, closure members 50, and a plurality of slats 60. The left and right side brackets 20 are respectively provided with a recessed engagement groove 21 indented at the corresponding inner side thereof A pair of protruded retaining ribs 22 each having a slant tapered guide facet 221 defining one end thereon are symmetrically disposed at the inner wall of the recessed engagement groove 21 thereon. The upper and lower side brackets 30 mounted to the recessed engagement grooves 21 thereof are respectively equipped with a pair of inserting recesses 31 symmetrically dented at both lateral sides thereon to be correspondingly registered with the protruded retaining ribs 22 of the left/right side brackets 20 thereby. The support member 40 is made of a frame-shaped and metallic tube to be located at the interior of the recessed engagement groove 21 therein. The closure member 50, made of solid plastics, has a pair of arc and oblique tapered guide ribs 51 and a pair of stop ribs 52 symmetrically extending in proper interval at both lateral sides thereon to define a pair of retaining cavities 53 of the same shape as the retaining ribs 22 there-between. A multiple of engaging holes 54 are equidistantly disposed at the corresponding inner lateral side of the closure members 50 thereof for pivoting posts 61 symmetrically extending at both sides of each slat 60 to be pivotally registered therewith. A linkage rod 62 is simultaneously attached at one side of each slat 60 for linking actuation of the slats 62 thereby.

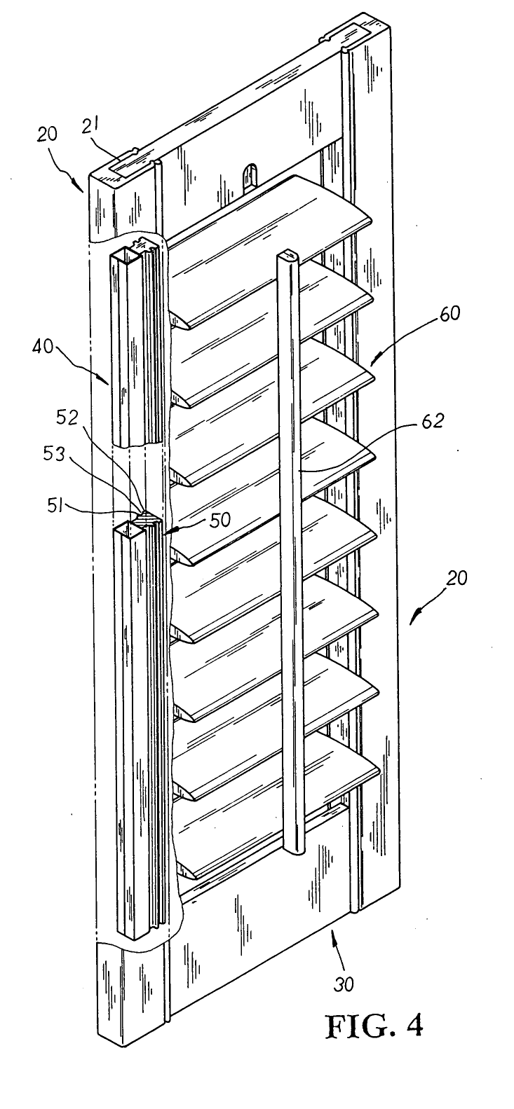

Please refer to FIGS. 4 to 5 inclusive. In assembly, the support members 40 are respectively adapted and located at the recessed engagement grooves 21 of the left/right side brackets 20 therein before the guide ribs 51 of the closure members 40 are respectively applied to the opening end of the recessed engagement grooves 21 thereof and forced through the guide facets 221 of the retaining ribs 22 till the retaining ribs 22 are precisely located at the retaining cavities 53 therein and securely limited in place by the guide ribs 51 and the stop ribs 52 of the closure members 50 so as to retain the closure members 50 stably at the recessed engagement grooves 21 of the left/right side brackets 20 therein as shown in FIG. 5. The pivoting posts 61 extending at both sides of each slat 60 are pivotally joined to the engaging holes 54 of the closure members 50 for location of the slat 60 thereby. The inserting recesses 31 of the upper/lower side brackets 30 are respectively led from the opening upper and lower sides of the recessed engagement grooves 21 thereof to be precisely registered with the retaining ribs 22 thereof and abutted against the upper and lower edges of the support members 40 and closure members 50 respectively to form a frame body and complete the assembly of the present invention. In practical use, the slats 60 are synchronically actuated to rotate open or close according to the linkage rod 62 moved upwards or downwards to adjust the sheltering position required. Meanwhile, the retaining ribs 22 of the recessed engagement grooves 21 are precisely abutted against the retaining cavities 53 of the closure members 50 and closely limited at the guide ribs 51 and stop ribs 52 of the closure members 50 there-between. Thus, while the slats 60 are pivotally rotated upwards or downwards by the linkage rod 62 thereof, the retaining cavities 53 of the closure members 50 are stably held in place without detaching from the recessed engagement grooves 21 thereof due to the linking actuation of the pivoting posts 61 attached to the engaging holes 54 of the closure members 50 thereof so as to achieve the best using condition thereof.

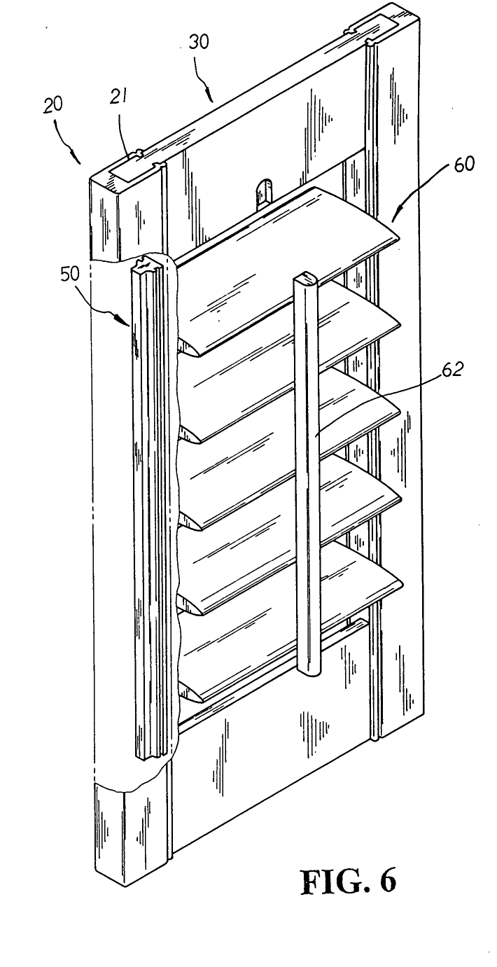

Please refer to FIGS. 6 to 7 inclusive. For a window frame of a smaller size as shown in FIG. 6, the retaining ribs 22 of the recessed engagement grooves 21 thereof are directly abutted against the retaining cavities 53 of the closure members 50 and securely limited in place by the guide ribs 51, and the stop ribs 51 thereof, and the closure members 40, made of solid plastics, are reinforced in strength so that the support members 40 are able to be omitted in assembly as shown in FIG. 7, economically saving the time of assembly as well as the cost of material to achieve the economical efficiency thereof and boost the competitive power of the present invention in the market.

1. A plastic ventilation window structure, including a left/right side bracket, an upper/lower side bracket, support members, closure members, and a plurality of slats; the present invention being characterized by that,
the left and right side brackets having a recessed engagement groove indented at the corresponding inner side thereof respectively, and a pair of protruded retaining ribs each having a guide facet defining one end thereon symmetrically disposed at the inner wall of the recessed engagement groove thereon; the upper and lower side brackets having a pair of inserting recesses symmetrically dented at both lateral sides thereon to be correspondingly registered with the protruded retaining ribs of the left/right side brackets thereby;
the closure member having a pair of guide ribs and stop ribs symmetrically extending in proper interval at both lateral sides thereon to define a pair of retaining cavities there-between;
in assembly, the retaining ribs of the recessed engagement grooves are precisely located at the retaining cavities of the closure members therein and closely limited in place at the guide ribs and stop ribs of the closure members there-between; thus, the closure members are stably retained at the left/right side brackets therein without detaching from the recessed engagement grooves thereof while the slats are pivotally rotated upwards or downwards by a linkage rod; in case of a smaller window frame, the closure members, reinforced in strength, are securely located via the retaining ribs of the recessed engagement grooves directly abutted against the retaining cavities and limited by the guide ribs and the stop ribs thereof so that the support members are able to be omitted in assembly, economically saving the time and cost of processing so as to achieve the economical efficiency and boost the competitive power thereof

2. The plastic ventilation window structure as claimed in claim 1 wherein the guide facet of the retaining rib of the recessed engagement groove thereof is defined by a slant and tapered surface thereon.

3. The plastic ventilation window structure as claimed in claim 1 wherein the closure member is made of solid plastics, and the guide ribs protruding at both lateral sides of the closure member are formed of arc and tapered shapes; besides, the retaining cavities defined by the guide ribs and the stop ribs thereof are shaped like the retaining ribs of the recessed engagement groove of the left/right side bracket thereof.
